(19) United States
(12) Patent Application Publication
(10) Pub. No.: US 2015/0261739 A1
(43) Pub. Date: Sep. 17, 2015

(54) Multi-Function Parser

(71) Applicant: Microsoft Corporation, Redmond, WA (US)

(72) Inventor: Frederico A. Mameri, Seatle, WA (US)

(73) Assignee: Microsoft Corporation, Redmond, WA (US)

(21) Appl. No.: 14/208,548

(22) Filed: Mar. 13, 2014

(51) Int. Cl. G06F 17/27; G06F 17/22

(52) U.S. Cl. CPC G06F 17/272; G06F 17/2247; G06F 17/227

(57) ABSTRACT

Technologies are described herein for communicating, processing and transforming data of a structured document. A parser and a consumer are configured to iteratively process data of a structured document without the need to create a complete and structured representation of the structured document in memory. The parser interprets and communicates individual data elements and associated properties of the structured document to the consumer. The consumer processes each data element before instructing the parser to send the next data element. If a predetermined condition is met, the parser discontinues the communication of the data elements of the structured document. According to various embodiments, the consumer may be configured to construct a generic version of the structured document. The consumer may also be configured to use data of the structured document to perform calculations, search functions, or any other type of processing or data conversion.

### BACKGROUND

Traditional parsers interpret data of structured documents based on an understanding of a particular grammar, which is defined by both data and associated properties. In existing systems, a parser reads an input file constructed with particular properties of a given language and constructs a complete and structured representation of the input file. The complete and structured representation is usually stored in memory which allows one or more consumer software components to understand and utilize the data.

One issue with existing systems, however, is that the construction of the complete and structured representation produced by the parser may not be the most optimal use of resources. For example, if a particular task of a consumer only needs part of the structured input file, construction of the complete and structured representation uses unnecessary amounts of processing cycles and system memory. In some cases, when web services communicate large structured input files, the use of existing systems for processing structured documents may also not be an optimal use of network bandwidth.

It is with respect to these considerations and others that the disclosure made herein is presented.

### SUMMARY

The technologies described herein may be utilized for communicating, processing and transforming data of a structured document. In embodiments disclosed herein, a parser and a consumer are configured to iteratively interpret data of a structured document without the need to create a complete and structured representation of the structured document in memory. A parser interprets and communicates individual data elements and associated properties of the structured document to a consumer. The consumer processes each data element before instructing the parser to send the next data element. If a predetermined condition of the consumer or the parser is met, the parser discontinues the processing and/or communication of the data elements of the structured document.

According to various embodiments, the consumer may be configured to construct a generic version of the structured document. As the parser communicates individual data elements and associated properties to the consumer, the consumer transforms the data element and/or the associated properties. The consumer may create a generic tree structure to store one or more elements, such as the received data element, the associated properties, the transformed data element and/or the transformed property. In some embodiments, techniques described herein are configured to generate a generic tree that is indistinguishable from the output of traditional parsers. In addition to creating a generic version of the structured document, techniques described herein may also create a modified version of the structured document.

According to various embodiments, the consumer may be configured to perform a number of complex operations on data stored in a structured document without the need to generate a complete and structured representation of the structured document in memory. For example, the consumer may be configured to process a document consisting of numbers. As the parser iteratively communicates individual data elements to the consumer, the consumer stores a count of the received data elements and a running total. As each data element is received and processed, the consumer sends an instruction to the parser, which directs the parser to send the next data element. This iterative process continues until the parser processes all of the data elements of the structured document or until a predetermined condition of the consumer is met. As can be appreciated, the consumer may also apply a filter, which limits the processing to data elements that are associated with a particular property. As a result, data of the structured document may be processed without the need to produce a complete and structured representation of the structured document in memory.

According to various embodiments, the consumer may be configured to search for desired data, such as a number or string, in a structured document. In such an embodiment, the parser may iteratively communicate individual data elements to the consumer. As the consumer receives each data element, the consumer examines the received data element to determine if it contains the desired data, such as a particular number or string. If it is determined that a received data element does not contain the desired data, the consumer sends an instruction to the parser to send the next data element. If it is determined that a received data element contains the string, the consumer may be configured to instruct the parser to terminate the communication between the parser and consumer. By using such techniques, a search of the structured document may be achieved without the need to produce a complete and structured representation of the structured document.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components for parsing and processing a structured document, according to one embodiment disclosed herein;

FIG. 2 is a block diagram showing several example computing devices for communicating an extensible markup language (“XML”) file to a parser, according to one embodiment disclosed herein;

FIGS. 3A-3B are protocol diagrams illustrating the communication between a parser and a consumer, according to one embodiment disclosed herein;

FIG. 4 is a flow diagram illustrating aspects of one illustrative routine for communicating and processing data of a structured document, according to one embodiment disclosed herein;

FIG. 5A is a flow diagram illustrating aspects of one illustrative routine for transforming data of a structured document, according to one embodiment disclosed herein;

FIG. 5B is a flow diagram illustrating aspects of one illustrative routine for processing data of a structured document using a knowledge base, according to one embodiment disclosed herein;

FIG. 5C is a flow diagram illustrating aspects of one illustrative routine for using data of a structured document to process variables, according to one embodiment disclosed herein; and

FIG. 6 is a computer architecture diagram showing an illustrative computer hardware and software architecture for a computing device capable of implementing aspects of the embodiments presented herein.

### DETAILED DESCRIPTION

The technologies described herein may be utilized for communicating, processing and transforming data of a structured document. In embodiments disclosed herein, a parser and a consumer are configured to iteratively interpret data of a structured document without the need to create a complete and structured representation of the structured document in memory. A parser interprets and communicates individual data elements and associated properties of the structured document to a consumer. The consumer processes each data element before instructing the parser to send the next data element. If a predetermined condition of the consumer or the parser is met, the parser discontinues the processing and/or communication of the data elements of the structured document.

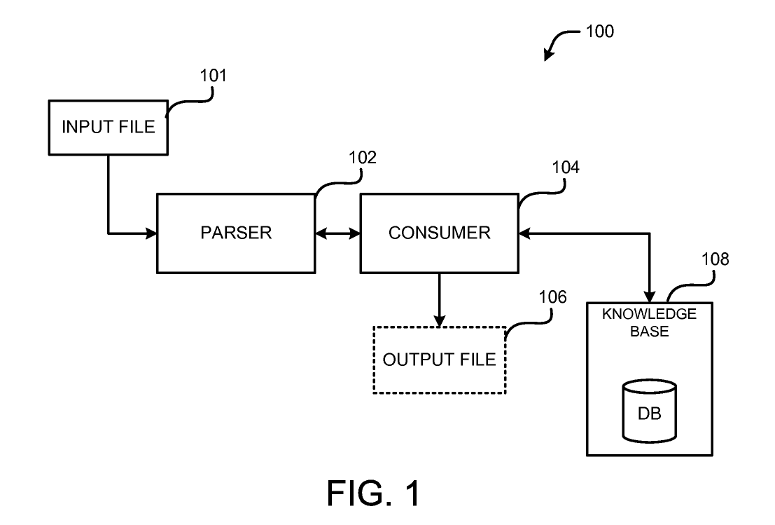

According to various embodiments, the consumer may be configured to construct a generic or modified version of the structured document. According to other various embodiments disclosed herein, the consumer may be configured to perform a number of operations and/or calculations using data of the structured document. Further, according to various embodiments, the consumer may be configured to search for desired data, such as a number or string, in a structured document. Additional details regarding these and other aspects of the technologies presented herein will be provided below with regard to FIGS. 1-6.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for communicating, processing and transforming data of a structured document will be described.

Turning now to FIG. 1, details will be provided regarding an illustrative operating environment and several software components provided by the embodiments presented herein. In particular, FIG. 1 shows aspects of a system 100 for communicating, processing and transforming data of an input file 101. The system 100 includes a parser 102, a consumer 104 and a knowledge base 108.

As can be appreciated, the input file 101 can be any structured document having one or more data elements. In addition, the input file 101 may or may not contain properties associated with each data element. In some illustrative examples, the input file 101 can contain programming code, an array of integers, an array of strings, or any other text having a specific grammar that can be read by a computing device. For illustrative purposes, the term “data” refers to both data elements and associated properties. For example, a data element may include any content of the document, such as a variable name in a C# file, and an associated property may be any description of the data element, such as a data type. In other non-limiting examples, a data element may simply be an integer or a floating point number having no associated properties.

As illustrated in FIG. 1, the parser 102 accesses the input file 101 and identifies individual data elements and properties associated with the data elements. An individual data element is communicated to the consumer 104 where the data element is processed using one or more operations. Once the consumer 104 receives the data element, the consumer 104 determines if an additional data element from the input file 101 is needed. As will be described in more detail below, this iterative process involving the communication and processing of individual data elements, gives the consumer 104 the ability to process data of the input file 101 without the need to construct a complete and structured representation of the input file 101 in memory.

As will be described in more detail below, either the consumer 104 or the parser 102 may determine the need for an additional data element from the input file 101. Depending on the desired result, the consumer 104 may be configured with one or more conditions to determine if additional data is needed. For instance, with reference to the above-described example involving a search string, if the consumer 104 is configured to search for a desired string in the input file 101, the consumer 104 may determine that additional data elements are needed if each received data element does not contain the desired string. However, after receiving a data element containing the desired string, the consumer 104 may determine that an additional data element is not needed, and the consumer 104 may instruct the parser 102 to discontinue the communication of the data elements of the input file 101. In yet another example, the parser 102 may determine that an additional data element from the input file 101 is not needed if the end of the input file 101 is reached.

As explained in more detail below, techniques disclosed herein enable the consumer 104 to perform one or more operations using the data elements of the input file 101. Some examples of the one or more operations include sorting, filtering and transforming the data of the input file 101. These examples are provided for illustrative purposes and are not to be construed as limiting, as the techniques described herein provide the consumer 104 with access to data of the input file 101 for any type of processing, storage and/or calculation. As can be appreciated, the parser 102 can be any type of parser that is configured to interpret the format and grammar of any input file. For illustrative purposes, one non-limiting example of the parser 102 includes a Simple API for XML (SAX) parser.

Depending on the desired result, in some embodiments, the consumer 104 may generate an output file 106. In one illustrative example where the output file 106 may be generated, the consumer 104 may be configured to construct a generic version of the input file 101. In other embodiments, as will be described in more detail below, the consumer 104 may not generate an output file 106. In such embodiments, the consumer 104 may update stored variables. Illustrative examples of such embodiments are described in detail below, some of which may include variables storing an average, sum or a combination of calculated values that are modified each time a data element is received by the consumer 104. In yet other embodiment, the consumer 104 may generate an in-memory representation of the input file 101 that is configured to be generically readable. The system 100 may also include a knowledge base 108, which may contain, or have access to, information that directs the consumer 104 on how to process the received data elements and/or associated properties.

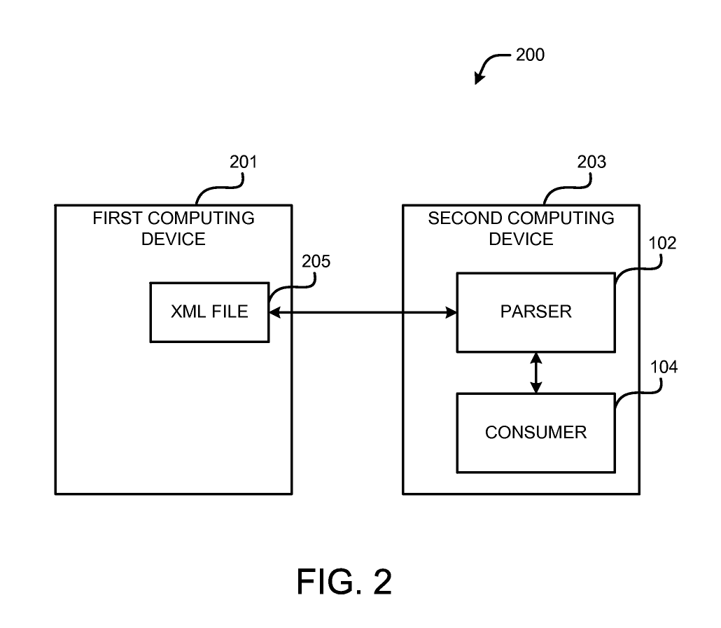

Referring now to FIG. 2, components of a computer system 200 for communicating an XML file 205 between a first computing device 201 and a second computing device 203 are shown according to one embodiment disclosed herein. The computer system 200 is configured to efficiently communicate a large XML file between the computing devices 201 and 203 and allow processing of the XML file 205 without the need to construct a complete and structured representation of the XML file 205 in memory. Further, and as described in more detail below, the iterative nature of the data processing may allow the computer system 200 to communicate the XML file 205 in sections, thus, in some scenarios, reducing the consumption of network resources between the computing devices 201 and 203.

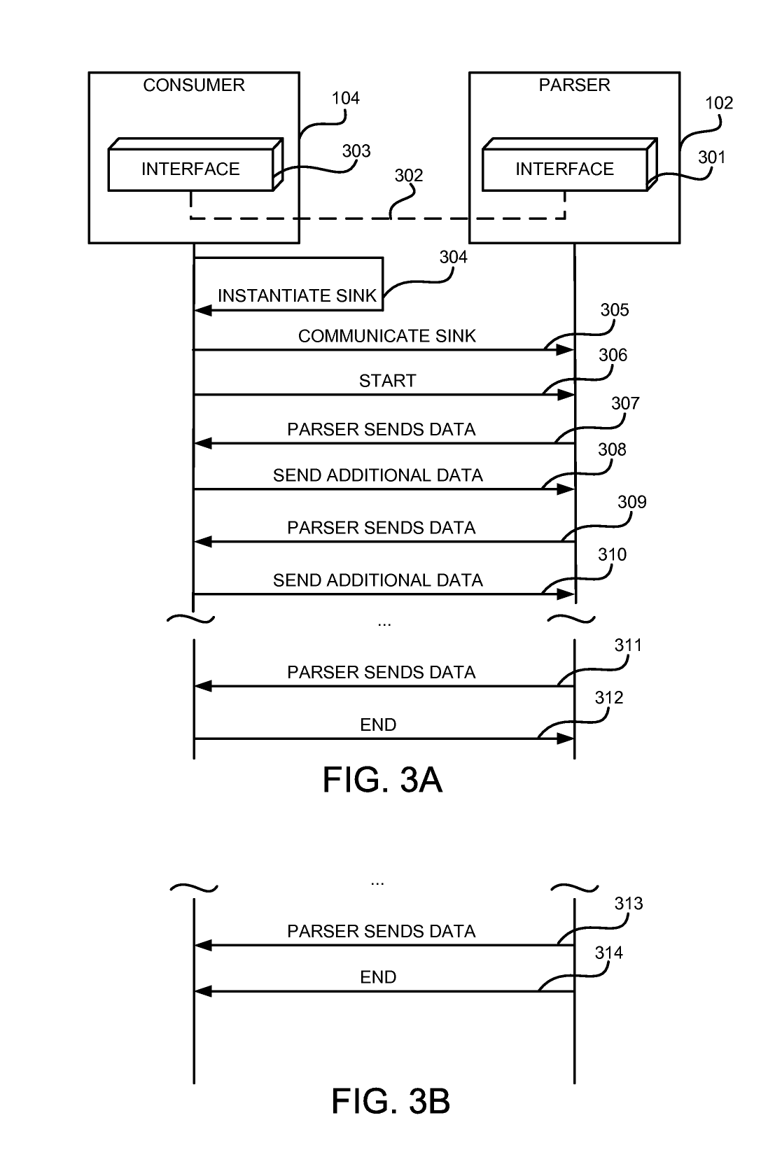

FIGS. 3A-3B are protocol diagrams that illustrate aspects of the iterative communication and processing stages between the parser 102 and the consumer 104 shown in FIGS. 1 and 2. The processing begins with the establishment of a sink 302 between an interface 301 of the parser 102 and an interface 303 of the consumer 104. As shown in FIG. 3A, the consumer 104 instantiates the sink 302 (at 304). Next, (at 305) the consumer 104 communicates the sink from the consumer 104 to the parser 102.

Once the sink 302 is established, the consumer 104 sends a request (at 306) to start the communication of the data. Next, the parser 102 obtains a data element from an input file 101 and sends the data element (at 307) to the consumer 104. As summarized above and described in more detail below, the consumer 104 may be configured to store, transform or otherwise process the received data. After the consumer 104 receives the data element, the consumer 104 communicates an instruction (at 308) to the parser 102, where the instruction directs the parser 102 to obtain an additional data element. Next (at 309), the parser 102 communicates the additional data element to the consumer 104. This iterative communication between the parser 102 and consumer 104 continues to cycle in the same manner where subsequent data elements of the input file 101 are sent (at 311) from the parser 102 to the consumer 104 each time the consumer 104 instructs the parser 102 to communicate an additional data element (at 310).

Either the consumer 104 or the parser 102 may terminate the processing and/or communication of the data. As shown in FIG. 3A, the consumer 104 may be configured to terminate the processing and/or communication of the data when one or more conditions are met. For example, with reference to the above-described illustrations, the consumer 104 may be configured to terminate the processing of data when it is verified that a string exists in a received data element, or the consumer 104 may be configured to terminate the processing of data if a variable reaches a threshold. When such conditions are met, the consumer 104 sends an instruction (at 312) to terminate the processing and/or communication of the data. As shown in FIG. 3B, the parser 102 may also provide an instruction (at 314) to terminate the processing and/or communication of the data when one or more conditions are met. In one illustrative example, the instruction (at 314) to end the communication and/or communication may be sent from the parser 102 to the consumer 104 once the last data element of the input file 101 is communicated (at 313).

The above-described example is provided for illustrative purposes and should not be construed as limiting. As can be appreciated, there are a number of ways to instantiate a parser, consumer and other components described above. For example, in a different implementation, the consumer 104 may instantiate a parser itself.

As can be appreciated, the iterative processing of individual data elements enables a computer system 200 to examine the input file 101 without the need for an entire representation to be constructed in memory. Since an entire representation does not need to be constructed in memory, the XML file 205 may be divided into sections and the sections may be iteratively communicated between the computing devices 201 and 203. Since each section of the file can be processed separately, the utilization of network resources may be reduced if fewer than all of sections are communicated between the computing devices 201 and 203. For example, with reference to the above-described examples, the consumer 104 may terminate processing of the data once a data element containing a specific string is received or if a variable reaches a threshold. In such scenarios, fewer than all sections of the XML file 205 may be communicated.

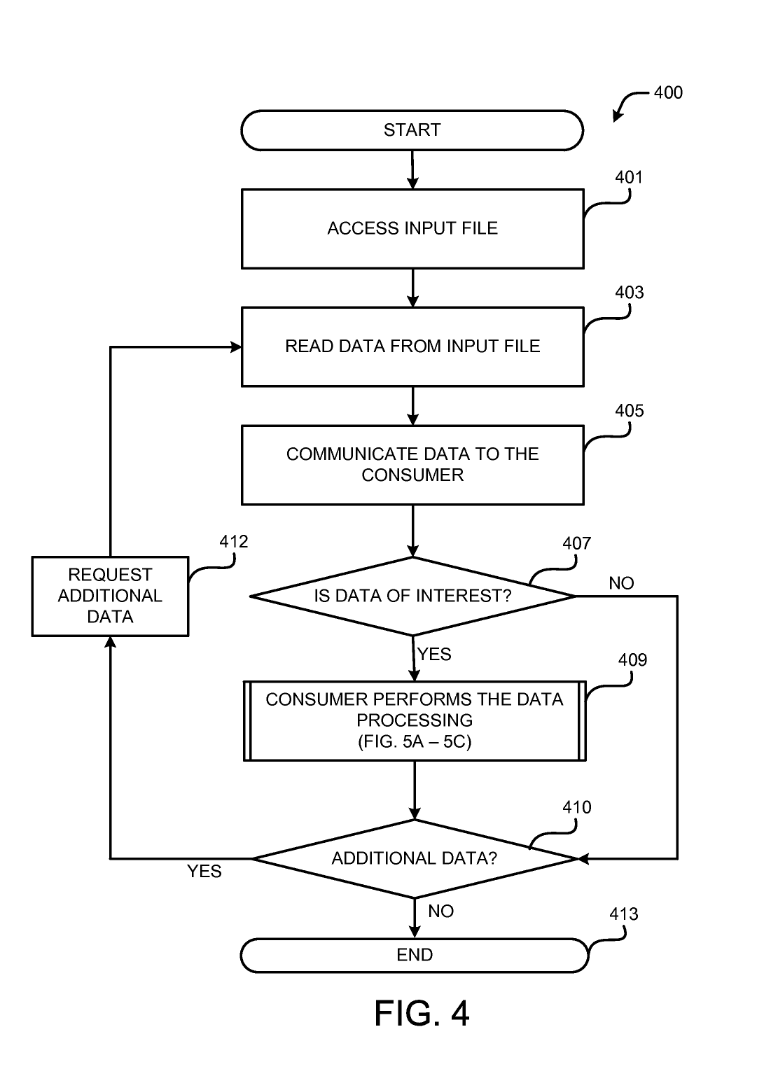

Referring now to FIG. 4, a flow diagram illustrating aspects of one illustrative routine 400 for communicating and processing data of a structured document will be described. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The implementation of the various components described herein is a matter of choice dependent on the performance and other requirements of the computing device. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the FIGURES and described herein. These operations may also be performed in parallel, or in a different order than those described herein.

The routine 400 begins at operation 401, where the parser 102 accesses the input file 101. As will be appreciated, the input file 101 can be any structured document containing individual data elements. In addition, the input file 101 may also contain property data, where individual properties may be associated with data elements. As summarized above, the input file 101 can contain programming code such as C#, C++, or the like. In another non-limiting example, the input file 101 can include an array of numbers or strings, which may or may not have associated properties. In yet another non-limiting example, the input file 101 can include contact information, which may label individual data elements as a phone number, address, city, state, etc. These examples are provided for illustrative purposes and are not to limit the scope of the disclosure herein, as the input file 101 may be any structured document having a specific grammar that can be read by a computer.

Next, at operation 403, the parser 102 reads a first data element from the input file 101. As can be appreciated, the parser 102 may perform a serial read of each data element of the input file 101. In such an embodiment, the parser 102 may select the first data element of the input file 101 regardless of the properties associated with the data element. In other embodiments, the parser 102 may use the associated properties and other data to filter and select particular data elements.

Next, at operation 405, the first data element is communicated from the parser 102 to the consumer 104. At operation 405, the communication of the first data element may also involve the communication of one or more properties associated with the first data element. The communication of the associated properties depends on the type of data that is stored in the input file 101. If the input file 101 contains an array of integers, operation 405 would involve the communication of the first integer of the array. If the input file 101 is an address book, the communication performed in operation 405 may involve a first listed data element, a name, and an associated property, e.g., a property noted as “<name>.”

Next, at operation 407, the consumer 104 determines if the received data element is of interest. The determination process of operation 407 may involve the analysis of the received data element and/or a property associated with the received data element. For example, if the consumer 104 is configured to calculate an average for the data of the input file 101, the consumer 104 may only read integers or floating point numbers and ignore all other data types. In another example, if the consumer 104 is configured to build a list of names from an address book, the consumer 104 may examine the associated property and only store data elements associated with a particular property, e.g., a property labeled as “<name>”. Other examples of operation 407 are provided below.

At operation 407, if the consumer 104 determines that the received data element is not of interest, the routine 400 proceeds to operation 410, where the consumer 104 or parser 102 determine if additional data is needed. However, if at operation 407, if the consumer 104 determines that the received data element is of interest, the routine 400 proceeds to operation 409, where the consumer 104 performs one or more operations to process the received data element.

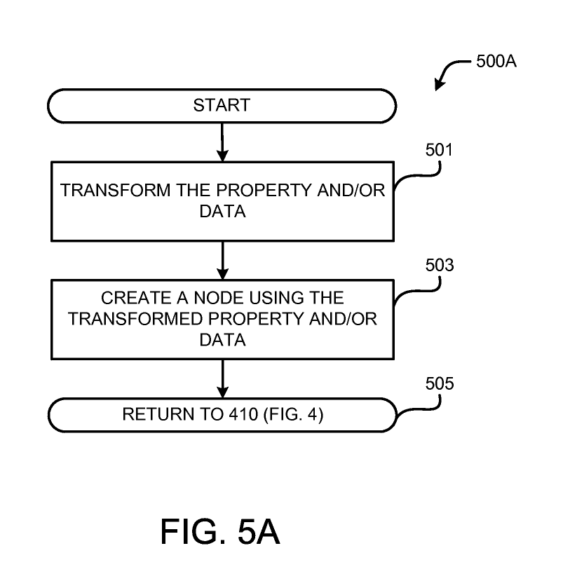

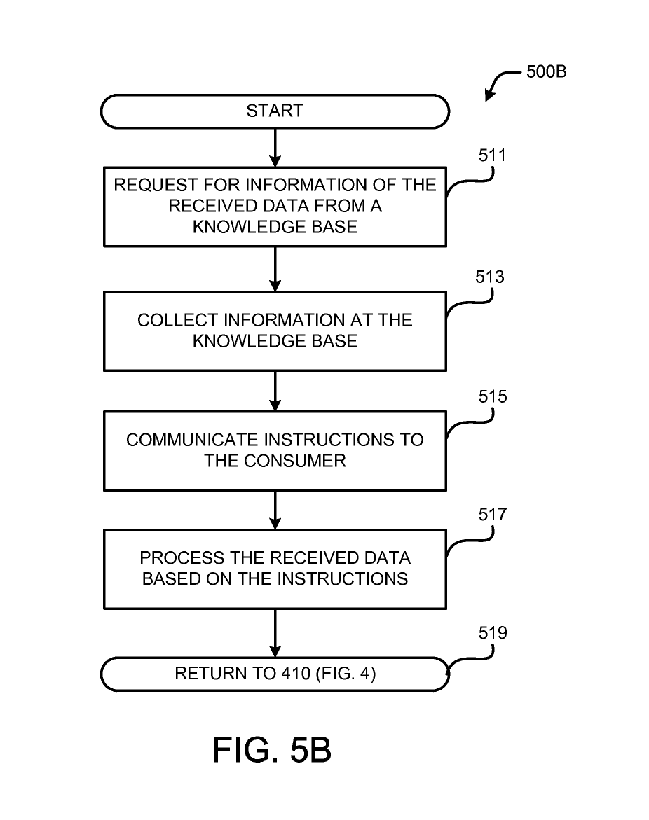

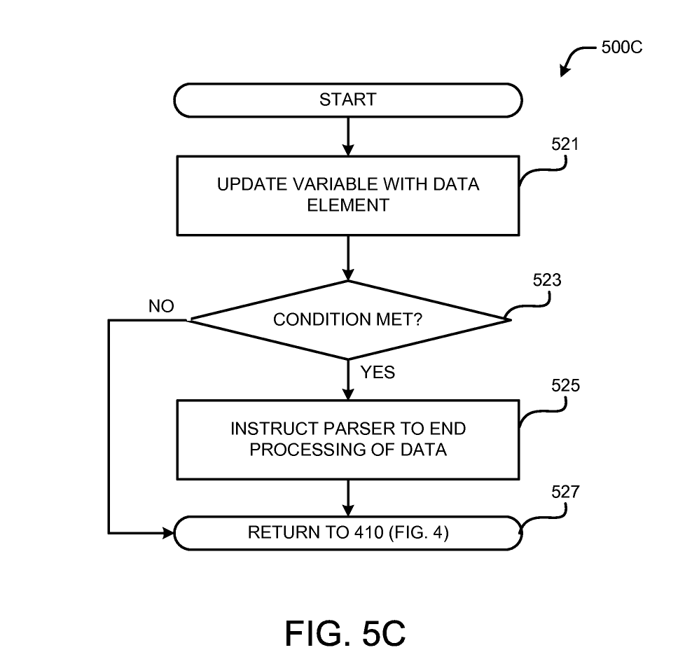

As summarized above, the consumer 104 may be configured to perform a wide range of operations using the received data. In some embodiments, for example, the consumer 104 may be used to calculate one or more values, such as an average or total. In other embodiments, the consumer 104 may be used to search for desired data, such as a particular string or number, in the input file 101. In yet another example, the consumer 104 may be configured to construct a generic version of the structured document. Additional details regarding these example operations, and other examples, will be described below in the descriptions of FIGS. 5A-5C.

After or during the execution of operation 409, the routine 400 proceeds to operation 410 where the consumer 104 determines if additional data is needed. As summarized above, the consumer 104 may be configured with one or more conditions to determine if additional data is needed. For example, if the consumer 104 is configured to search for a desired string in the input file 101, the consumer 104 may determine that additional data elements are needed if each received data element does not contain the desired string. However, after receiving a data element with the desired string, the consumer 104 may determine that an additional data element is not needed. If an additional data element is not needed, the consumer 104 instructs the parser 102 to discontinue the communication and/or processing of the data elements and/or associated properties of the input file 101. These examples are provided by way of illustration only and should not be construed as limiting.

In other embodiments, the consumer may access a knowledge base 108 to determine if additional data is needed. In such an embodiment, the knowledge base 108 may interact with a user or other computing devices to determine if additional data is needed. For instance, the knowledge base 108 may display the status of the routine 400 to the user, and allow the knowledge base 108 to receive input from the user. The knowledge base 108 may process the user input with other data to determine if additional data is needed.

As can be appreciated, operation 410 may also involve processing at the parser 102. For instance, the parser 102 may be configured to terminate routine 400 if the parser 102 determines that it has reached the end of the input file 101. In addition, the parser 102 may receive an instruction from the knowledge base 108 and/or the consumer 104, and process the received instruction with other information to determine if additional data is needed. These examples are provided by way of illustration only and should not be construed as limiting.

If the parser 102 and/or the consumer 104 determine that no additional data elements are needed, the routine 400 terminates at operation 413. However, if at operation 410, if it is determined that at least one an additional data element is needed, the routine 400 proceeds to 412 where the consumer 104 communicates a request to the parser 102 for an additional data element and/or associated property from the input file 101. From operation 412, the routine 400 proceeds to operation 403 where an additional data element and/or associated properties is/are extracted from the input file 101. From operation 403 the routine 400 repeats operations 403-412 until the parser 102 or consumer 104 determine that no additional data elements are needed.

By the use of the routine 400, the consumer 104 may perform a wide-range of calculations without the need to generate a complete and structured representation of the input file 101 in memory. For example, in one illustrative example, the consumer 104 may be configured to calculate an average for the data elements of the input file 101. For illustrative purposes, consider a scenario where the input file 101 contains an array of integers. In applying routine 400 to this example, at operation 401, the parser 102 accesses the input file 101. At operation 403, the first integer in the input file 101 is extracted by the parser 102. At operation 405, the first integer is communicated from the parser 102 to the consumer 104. At operation 407, the consumer 104 can be configured to compare the function to the data type to determine if the first integer is of interest. Given, in this illustration, that the consumer 104 is calculating an average and given that the extracted data element is a valid data type, an integer, for that calculation, the consumer 104 determines that the first integer is of interest.

Next, at operation 409, the consumer 104 updates two variables using the first integer: a count of the received data elements and a running total summing the received integers. The routine 400 repeats operations 403-412 until all of the data elements of the input file 101 have been processed. Alternatively, in another embodiment where the consumer 104 is configured with a pre-determined threshold, routine 400 repeats operations 403-412 until the count, the running total, or another value reaches the pre-determined threshold.

As can be appreciated, a traditional approach for processing such an input file 101 would require a reproduction of a complete and structured representation of the input file 101 in memory. As can be appreciated, if the input file 101 contained millions or billions of data elements, use of memory resources are substantial. Using the techniques described herein, the use of memory resources are reduced as the above-described example only stores two variables.

Referring now to FIGS. 5A-5C, additional details regarding several illustrative embodiments for performing operation 409 of FIG. 4 will be provided. As summarized above, the consumer 104 may be configured to perform a number of different operations using data of the input file 101. As described below, and shown in FIGS. 5A-5C, various operations on the data may be performed individually or in combination.

FIG. 5A is a flow diagram illustrating a routine 500A for transforming data and/or associated properties of the input file 101. As will be explained in more detail below, the routine 500A may be used to create a modified version of the input file 101. In addition, the routine 500A may be used to construct a generic version of the input file 101. Generally described, as the consumer 104 iteratively receives data elements and associated properties from the parser 102, the consumer 104 may transform the data element and/or the associated properties. The transformed data and/or transformed properties may be saved to the output file 106 and/or used in memory of the consumer 104. In addition, the transformed data and/or transformed properties may be saved in a tree structure, or any other desired structure having a specific grammar.

The routine 500A begins at operation 501 where the consumer 104 transforms the data element and/or the associated property communicated to the consumer 104 (operation 405 of FIG. 4). More specifically, operation 501 may involve the transformation of the data element, the associated property, or a combination of both the data element and associated property. The type of transformation of the data element and/or the associated property depends on the desired output and the configuration of the consumer 104. Examples illustrating such transformations are explained in detail below.

Next, at operation 503, the consumer 104 creates a node for a modified or a generic document structure using the data element, the associated property, the transformed data element and/or the transformed associated property. The structure of the modified document or the generic document depends on the desired output and the configuration of the consumer 104. Examples illustrating such structures are explained in detail below.

As will be appreciated, the node resulting from operation 503 may or may not be stored in an output file 106. Depending on the configuration of the consumer 104 and the desired output, the newly created node may be stored in memory to be used by another software module, or stored in a file, such as the output file 106. From operation 503, the routine 500A proceeds to operation 505, where the routine 500A returns to operation 410 of FIG. 4.

As summarized above, the routine 500A may be used to create a modified version of the input file 101. For illustrative purposes, consider a scenario where the input file 101 contains a list of phone numbers, and the phone numbers in the list have different formats: some have an area code, some do not have an area code, some have hyphens, some do not have hyphens, etc. If the consumer 104 is configured to normalize the phone numbers into a unified format, at operation 501, the consumer 104 transforms each data element that is received in operation 405. In such an example, as each phone number is iteratively sent from the parser 102, the consumer 104 may add area codes, remove or add hyphens, etc.

In addition, the consumer 104 may access data in the knowledge base 108 to verify, correct or replace missing data. The use of the knowledge base 108 may involve the use of other resources, such as queries to web services, social networks, external or internal databases, etc. Next, in applying operation 503 to the current example, each modified data element may be stored in memory or in the output file 106. This example and other examples presented herein are intended to be illustrative and not limiting.

In addition to creating a modified version of the input file 101, the routine 500A may be used to create a generic version of the input file 101. For illustrative purposes, consider a scenario where the input file 101 contains tag data for a Web service, such as YouTube. In the instant example, each data element of the input file 101 includes an array of words in a first language, e.g., English. If it is desired to use the tag data to target an audience in a foreign country, requiring a different language, a conversion of the input file 101 is needed.

To address this need, the consumer 104 may be configured to receive each data element from the input file 101 and apply operation 501 to translate each word from the first language, e.g., English, to a second language, e.g., French. As can be appreciated, the consumer may access a knowledge base 108 and other resources, such as the BING TRANSLATOR translation service from MICROSOFT CORPORATION of Redmond, Wash., to facilitate the translation. Next, in applying operation 503, each transformed data element is stored in the output file 106, thus creating a generic version of the input file 101 having a different language.

In yet another non-limiting example, the consumer may transform the properties of the input file 101 containing a first programming language to create an output file containing a second programming language or markup language. In a specific example, the parser may interpret elements of the input file containing C# code and iteratively communicate each data element, e.g., a variable name, and an associated property, e.g., a data type, to the consumer. The consumer may then transform the data element and/or the property into a grammar that comports any desired programming language or markup language. In a specific non-limiting example, the consumer may transform a file or a set of files containing C# code into a file containing code of another language, such as C++.

FIG. 5B is a flow diagram illustrating a routine 500B for utilizing the knowledge base 108 to process the data element and/or the associated property communicated to the consumer 104 (operation 405 of FIG. 4). Generally described, the knowledge base 108 may provide data or instructions to the consumer 104 to assist in the processing of the data element and/or the associated property. In addition, the knowledge base 108 may provide data to help determine if the data element and/or the associated property is relevant to a function, process or calculation to be performed. In addition, the consumer 104 may utilize information from the knowledge base 108 to determine if additional data elements are needed (410 of FIG. 4).

The routine 500B begins at operation 511 where the consumer 104 sends a request to the knowledge base 108 for information and/or resources to assist in the processing of the data element and/or the associated property. The request may include the data element and/or associated property communicated in operation 405 of FIG. 4. The request may also include information describing the data element or the associated property. In addition, the request may include contextual information or data that may be used for other functions, such as constructing a query to a search engine, social network, or any type of database or service.

Next, at operation 513, the knowledge base 108 processes the request by accessing one or more resources to collect information related to the data element and/or associated property. The collected information may come from one or more resources, such as a database, one or more functions of the knowledge base 108, an external service, an internal service, etc. Illustrative examples of resources of the knowledge base 108 may include a search engine, social network, a Web service, a public API of web site, etc.

The information provided in the request generated in operation 511 is used to collect the information related to the data element and/or associated property. For example, the information provided in the request may be used to build a query to a database containing a dictionary, phone book, programming code, etc. Using such available resources, the knowledge base 108 can collect, generate, and process data or instructions that may assist in transforming, processing, or determining the relevancy of the data element and/or associated property.

The knowledge base 108 may also include a mechanism for displaying the data element and/or associated property or information related to the data element and/or the associated property on a user interface. The knowledge base 108 may also provide a mechanism that allows a user to provide an input in response to the display of the data element and/or associated property. The user input may provide data or instructions that may assist the consumer 104 in transforming, processing, or determining the relevancy of the data element and/or associated property. In addition, the user input may be combined with other data or instructions.

Next, at operation 515, the data or instructions generated in operation 513 is communicated from the knowledge base 108 to the consumer 104. At operation 517, the consumer 104 utilizes the data or instructions received from the knowledge base 108 to transform, process or determine the relevancy of the data element and/or associated property. From operation 517, the routine 500B proceeds to operation 519, where the routine 500B returns to operation 410 of FIG. 4.

FIG. 5C is a flow diagram illustrating a routine 500C for using data of a structured document to process one or more variables maintained on the consumer 104. Generally described, the consumer 104 may be configured with one or more variables that may be used for any process or function. As summarized above, the techniques disclosed herein provide a way for the parser 102 and the consumer 104 to iteratively update the one or more variables of the consumer and automatically terminate the processing once a pre-determined condition is met.

The routine 500C begins at operation 521 where the consumer 104 updates the one or more variables using the data element and/or associated property. In applying the above-described example where the consumer 104 is configured to calculate an average, operation 521 updates two variables stored on the consumer 104 using the data element obtained in operation 405 of FIG. 4. As noted above, in this non-limiting example, the two variables include: a count of the received data elements and a running total.

Next, at operation 523, the consumer 104 determines if the variables meet a pre-determined condition. For example, the consumer 104 may be configured to terminate processing of routine 500C if the count reaches a threshold and/or if the average reaches a threshold. It can be appreciated that operation 523 may involve a wide range of thresholds or conditions, these examples are intended to be illustrative and not limiting.

If one or more values of the updated variables meet a pre-determined condition, for example, if the count reaches a specific number or the average reaches a specific number, the routine 500C proceeds to operation 525, where the consumer 104 determines that no additional data elements are needed, and an instruction is sent to the parser 102 to terminate the processing of the data of the input file 101. From operation 525, the routine 500C proceeds to operation 527, where both routines 500C and 400 terminate. Alternatively, at operation 523, if the one or more values of the updated variables do not meet a pre-determined condition, the routine 500C proceeds to operation 527 where routine 500C returns to operation 410 of FIG. 4.

As can be appreciated, a traditional approach for processing such an input file 101 would require a reproduction of a complete and structured representation of the input file 101 in memory. Although the above-described example illustrates a variable that is maintained on the consumer 104, it can be appreciated that the techniques described herein may maintain and update variables, databases, services on any type of computer.

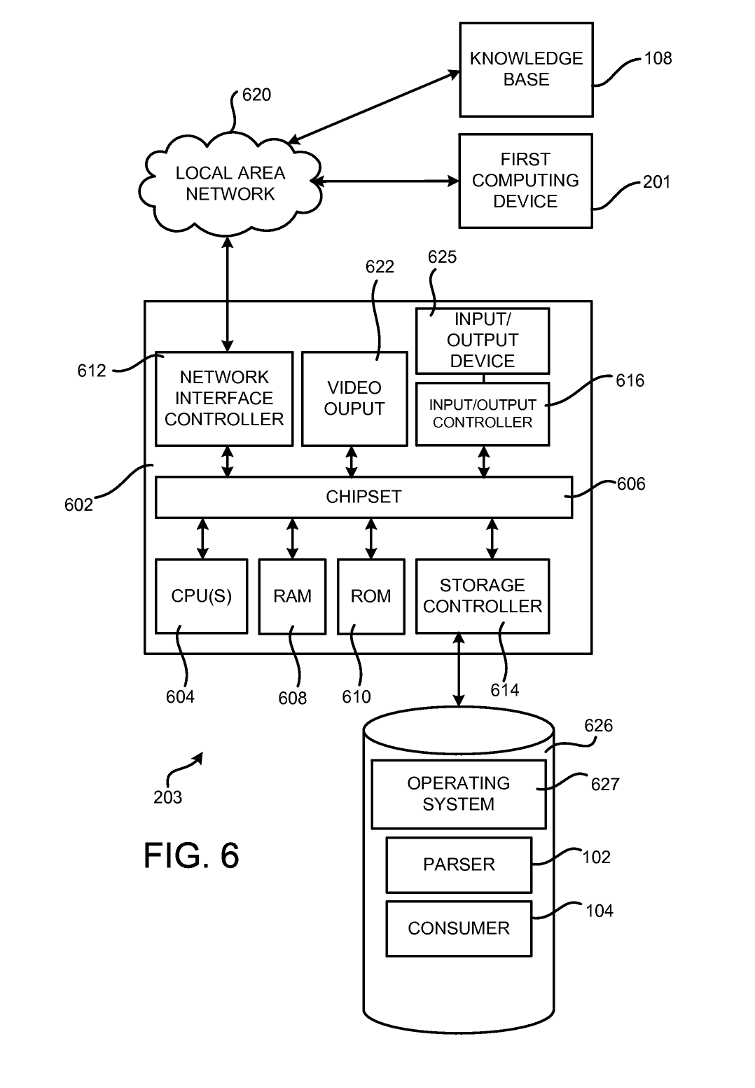

FIG. 6 shows additional details of an example computer architecture for the computing device 203 (FIG. 2) capable of executing the program components described above for processing data elements of a structured document. The computer architecture shown in FIG. 6 illustrates a conventional server computer, workstation, desktop computer, laptop, tablet, phablet, network appliance, personal digital assistant (“PDA”), e-reader, digital cellular phone, or other computing device, and may be utilized to execute any of the software components presented herein. For example, the computer architecture shown in FIG. 6 may be utilized to execute any of the software components described above.

The computing device 203 includes a baseboard 602, or “motherboard,” which is a printed circuit board to which a multitude of components or devices may be connected by way of a system bus or other electrical communication paths. In one illustrative embodiment, one or more central processing units (“CPUs”) 604 operate in conjunction with a chipset 606. The CPUs 604 may be standard programmable processors that perform arithmetic and logical operations necessary for the operation of the computing device 203.

The CPUs 604 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 may provide an interface to a RAM 608, used as the main memory in the computing device 203. The chipset 606 may further provide an interface to a computer-readable storage medium such as a read-only memory (“ROM”) 610 or non-volatile RAM (“NVRAM”) for storing basic routines that help to startup the computing device 203 and to transfer information between the various components and devices. The ROM 610 or NVRAM may also store other software components necessary for the operation of the computing device 203 in accordance with the embodiments described herein.

The computing device 203 may operate in a networked environment using logical connections to remote computing devices and computer systems through a network, such as the local area network 620. The chipset 606 may include functionality for providing network connectivity through a network interface controller (NIC) 612, such as a gigabit Ethernet adapter. The NIC 612 is capable of connecting the computing device 203 to other computing devices over the network 620. It should be appreciated that multiple NICs 612 may be present in the computing device 203, connecting the computer to other types of networks and remote computer systems. The local area network 620 allows the computing device 203 to communicate with remote services and servers, such as the first computing device 201 and the knowledge base 108.

The computing device 203 may be connected to a mass storage device 626 that provides non-volatile storage for the computing device. The mass storage device 626 may store system programs, application programs, other program modules, and data, which have been described in greater detail herein. The mass storage device 626 may be connected to the computing device 203 through a storage controller 614 connected to the chipset 606. The mass storage device 626 may consist of one or more physical storage units. The storage controller 614 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. It should also be appreciated that the mass storage device 626, other storage media and the storage controller 614 may include MultiMediaCard (MMC) components, eMMC components, Secure Digital (SD) components, PCI Express components, or the like.

The computing device 203 may store data on the mass storage device 626 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 626 is characterized as primary or secondary storage, and the like.

For example, the computing device 203 may store information to the mass storage device 626 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 203 may further read information from the mass storage device 626 by detecting the physical states or characteristics of one or more particular locations within the physical storage units.

In addition to the mass storage device 626 described above, the computing device 203 may have access to other computer-readable media to store and retrieve information, such as program modules, data structures, or other data. Thus, although the parser 102, consumer 104 and other modules are depicted as data and software stored in the mass storage device 626, it should be appreciated that the parser 102 and the consumer 104 and/or other modules may be stored, at least in part, in other computer-readable storage media of the computing device 203. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computing device 203.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 203. For purposes of the claims, the phrase “computer storage medium,” and variations thereof, does not include waves or signals per se and/or communication media.

The mass storage device 626 may store an operating system 627 utilized to control the operation of the computing device 203. According to one embodiment, the operating system comprises the LINUX operating system. According to another embodiment, the operating system comprises the WINDOWS® operating system from MICROSOFT Corporation. According to further embodiments, the operating system may comprise the UNIX, Android, Windows Phone or iOS operating systems. It should be appreciated that other operating systems may also be utilized. The mass storage device 626 may store other system or application programs and data utilized by the computing device 203, such as input file 101 and the output file 106 and/or any of the other software components and data described above. The mass storage device 626 might also store other programs and data not specifically identified herein.

In one embodiment, the mass storage device 626 or other computer-readable storage media is encoded with computer-executable instructions which, when loaded into the computing device 203, transform the computer from a general-purpose computing system into a special-purpose computer capable of implementing the embodiments described herein. These computer-executable instructions transform the computing device 203 by specifying how the CPUs 604 transition between states, as described above. According to one embodiment, the computing device 203 has access to computer-readable storage media storing computer-executable instructions which, when executed by the computing device 203, perform the various routines described above with regard to FIGS. 4 and 5A-5C. The computing device 203 might also include computer-readable storage media for performing any of the other computer-implemented operations described herein.

The computing device 203 may also include one or more input/output controllers 616 for receiving and processing input from a number of input devices, such as a keyboard, a mouse, a microphone, a headset, a touchpad, a touch screen, an electronic stylus, or any other type of input device. Also shown, the input/output controllers 616 is in communication with an input/output device 625. Similarly, the input/output controller 616 may provide output to a display, such as a computer monitor, a flat-panel display, a digital projector, a printer, a plotter, or other type of output device. In addition, or alternatively, a video output 622 may be in communication with the chipset 606 and operate independent of the input/output controllers 616. It will be appreciated that the computing device 203 may not include all of the components shown in FIG. 6, may include other components that are not explicitly shown in FIG. 6, or may utilize an architecture completely different than that shown in FIG. 6.

Based on the foregoing, it should be appreciated that technologies for processing data of a structured document are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computing device, comprising:
a processor;
a memory; and
a parser module and a consumer module, both of which execute in the processor from the memory, and which when executed by the processor, cause the computing device to process data of a structured document, wherein the data comprises one or more of data elements and associated properties by
identifying a data element of the one or more data elements,
communicating the data element and at least one associated property from the parser module to the consumer module,
processing the data element or the at least one associated property according to an operation of the consumer module,
determining if additional data from the structured document is needed for processing by the consumer module,
if it is determined that additional data from the structured document is needed, communicating a continuation instruction from the consumer module to the parser module, wherein the continuation instruction causes the parser module to identify an additional data element and communicate the additional data element from the parser module to the consumer module, and
if it is determined that additional data from the structured document is not needed, causing the parser module to discontinue processing of the data of the structured document.

2. The computing device of claim 1, wherein the operation of the consumer module comprises:
transforming the at least one associated property to at least one transformed property; and
creating a node in a generic tree structure, the node associated with the data element and the at least one transformed property.

3. The computing device of claim 1, wherein the operation of the consumer module comprises:
transforming the data element to a transformed data element; and
creating a node in a generic tree structure, the node associated with the transformed data element.

4. The computing device of claim 1, wherein the operation of the consumer module comprises:
determining if the data element matches a search term;
if it is determined that the data element does not match the search term, determining that additional data from the structured document is needed; and
if it is determined that the data element matches the search term, determining that additional data from the structured document is not needed.

5. The computing device of claim 1, wherein the operation of the consumer module comprises:
accessing a knowledge base for an instruction indicating a relevancy of the data element or the at least one associated property; and
processing the data element or the at least one associated property, wherein the processing is based on the instruction indicating the relevancy of the data element or the at least one associated property.

6. The computing device of claim 1, wherein determining if additional data from the structured document is needed, comprises:
accessing a knowledge base for information indicating a need for further processing of the data of the structured document; and
determining that additional data from the structured document is needed based on the accessed information.

7. The computing device of claim 1, wherein the operation of the consumer module comprises:
sending a request to a knowledge base, the request comprising the data element or at least one associated property;
in response to the request, receiving an instruction or related data from the knowledge base; and
processing the data element or the at least one associated property utilizing the instruction or the related data from the knowledge base.

8. The computing device of claim 1, wherein the operation of the consumer module comprises:
updating one or more variables using the data element;
determining if the one or more variables reach a pre-determined threshold; and
if the one or more variables reach the pre-determined threshold, determining that additional data from the structured document is not needed.

9. A computer-implemented method for processing one or more data elements of a structured document, the method comprising performing computer-implemented operations for:
identifying a data element of the one or more data elements of the structured document;
communicating the data element from a parser module to a consumer module;
processing the data element according to an operation of the consumer module;
determining if an additional data element from the structured document is needed for processing by the consumer module;
if it is determined that the additional data element is needed, communicating a continuation instruction from the consumer module to the parser module, wherein the continuation instruction causes the parser module to identify the additional data element and communicate the additional data element from the parser module to the consumer module; and
if it is determined that the additional data element is not needed, causing the parser module to discontinue processing of the structured document.

10. The computer-implemented method of claim 9, further comprising:
determining if a last data element of the structured document has been communicated from the parser module to the consumer module; and
if the last data element of the structured document has been communicated from the parser module to the consumer module, determining that the additional data element from the structured document is not needed.

11. The computer-implemented method of claim 9, wherein the operation of the consumer module comprises:
transforming the data element to a transformed data element; and
creating a node in a generic tree structure, wherein the node contains the transformed data element.

12. The computer-implemented method of claim 9, wherein the operation of the consumer module comprises:
determining if the data element matches a search term; and
if it is determined that the data element matches the search term, determining that additional data from the structured document is not needed.

13. The computer-implemented method of claim 9, wherein the operation of the consumer module comprises:
accessing a knowledge base for an instruction indicating a relevancy of the data element or the at least one associated property; and
processing the data element or the at least one associated property, wherein the processing is based on the instruction indicating the relevancy of the data element or the at least one associated property.

14. The computer-implemented method of claim 9, wherein the operation of the consumer module comprises:
sending a request to a knowledge base, the request comprising the data element or at least one associated property;
in response to the request to the knowledge base, receiving an instruction or related data from the knowledge base; and
processing the data element or the at least one associated property utilizing the instruction or the related data from the knowledge base.

15. A computer storage medium having computer-executable instructions stored thereupon which, when executed by a computing device, cause the computing device to:
access a structured document comprising one or more data elements;
identify a data element of the one or more data elements;
communicate the data element from a parser module to a consumer module;
process the data element according to an operation of the consumer module, the operation comprising creating a modified version of the structured document, processing a variable or searching for a search term;
determine if an additional data element from the structured document is needed for processing by the consumer module;
if it is determined that the additional data element is needed, communicate a continuation instruction from the consumer module to the parser module, wherein the continuation instruction causes the parser module to identify the additional data element and communicate the additional data element from the parser module to the consumer module; and
if it is determined that the additional data element is not needed, causing the parser module to discontinue processing of the structured document.

16. The computer storage medium of claim 15, wherein processing the variable comprises:
updating the variable using the data element;
determining if the variable reaches a pre-determined threshold; and
if the variable reaches the pre-determined threshold, determining that additional data from the structured document is not needed.

17. The computer storage medium of claim 15, wherein creating the modified version of the structured document comprises:
transforming the data element to a transformed data element; and
creating a node in a generic tree structure, wherein the node contains the transformed data element.

18. The computer storage medium of claim 15, wherein searching for the search term comprises:
determining if the data element matches the search term;
if it is determined that the data element does not match the search term, determining that additional data from the structured document is needed; and
if it is determined that the data element matches the search term, determining that additional data from the structured document is not needed.

19. The computer storage medium of claim 15, wherein the operation of the consumer module comprises:
accessing a knowledge base for an instruction indicating a relevancy of the data element or the at least one associated property; and
processing the data element or the at least one associated property, wherein the processing is based on the instruction indicating the relevancy of the data element or the at least one associated property.

20. The computer storage medium of claim 15, wherein the wherein the computer-executable instructions further cause the computing device to:
determine if a last data element of the structured document has been communicated from the parser module to the consumer module; and
if the last data element of the structured document has been communicated from the parser module to the consumer module, determine that the additional data element from the structured document is not needed.
